(19) United States
(12) Patent Application Publication
(10) Pub. No.: US 2021/0102146 A1
(43) Pub. Date: Apr. 8, 2021

(54) TERNARY AND QUATERNARY AZEOTROPE AND AZEOTROPE-LIKE COMPOSITIONS COMPRISING PERFLUOROHEPTENE

(71) Applicant: THE CHEMOURS COMPANY FC, LLC, Wilmington, DE (US)

(72) Inventor: Harrison K. MUSYIMI, Bear, DE (US)

(73) Assignee: THE CHEMOURS COMPANY FC, LLC, WILMINGTON, DE (US)

(21) Appl. No.: 17/051,814

(22) PCT Filed: May 1, 2019
(86) PCT No.: PCT/US2019/030107

§ 371 Date: Oct. 30, 2020

Related U.S. Application Data
(60) Provisional application No. 62/666,463, filed on May 3, 2018.

(51) Int. Cl. C11D 7/50; C11D 11/00

(52) U.S. Cl. CPC C11D 7/5054; C11D 11/0011

(57) ABSTRACT

The present application provides ternary and quaternary azeotrope or azeotrope-like compositions comprising perfluoroheptene and two or more additional components, wherein the additional components are present in the composition in amounts effective to form an azeotrope composition or azeotrope-like composition with the perfluoroheptene. Methods of using the compositions provided herein in cleaning and carrier fluid applications are also provided.

### CROSS-REFERENCE TO RELATED APPLICATIONS

This application claims the benefit of U.S. Provisional Application Ser. No. 62/666,463, filed May 3, 2018, the disclosure of which is incorporated herein by reference in its entirety.

### TECHNICAL FIELD

This invention relates to ternary and quaternary azeotrope or azeotrope-like compositions comprising perfluoroheptene and two or more additional components, wherein the additional components are present in the composition in amounts effective to form an azeotrope composition or azeotrope-like composition with the perfluoroheptene. The compositions described herein may be useful, for example, in cleaning and carrier fluid applications.

### BACKGROUND

Chlorofluorocarbon (CFC) compounds have been used extensively in the area of semiconductor manufacture to clean surfaces such as magnetic disk media. However, chlorine-containing compounds such as CFC compounds are considered to be detrimental to the Earth's ozone layer. In addition, many of the hydrofluorocarbons used to replace CFC compounds have been found to contribute to global warming. Therefore, there is a need to identify new environmentally safe solvents for cleaning applications, such as removing residual flux, lubricant or oil contaminants, and particles. There is also a need for identification of new solvents for deposition of fluorolubricants and for drying or dewatering of substrates that have been processed in aqueous solutions.

### SUMMARY

The present application provides, inter alia, a composition, comprising:

i) perfluoroheptene;

ii) n-heptane; and

iii) a compound selected from tert-butyl acetate and isopropyl acetate;

wherein each of the n-heptane and tert-butyl acetate or isopropyl acetate are present in the composition in amounts effective to form an azeotrope composition or azeotrope-like composition with the perfluoroheptene.

The present application further provides a composition, comprising:

i) perfluoroheptene;

ii) HFC-4310mee; and

iii) trans-1,2-dichloroethylene;

wherein the HFC-4310mee and trans-1,2-dichloroethylene are each present in the composition in amounts effective to form an azeotrope composition or azeotrope-like composition with the perfluoroheptene.

The present application further provides processes for dissolving a solute, comprising contacting and mixing said solute with a sufficient quantity of a composition described herein.

The present application further provides a processes of cleaning a surface, comprising contacting a composition described herein with said surface.

The present application further provides a process for removing at least a portion of water from the surface of a wetted substrate, comprising contacting the substrate with a composition described herein, and then removing the substrate from contact with the composition.

Unless otherwise defined, all technical and scientific terms used herein have the same meaning as commonly understood by one of ordinary skill in the art to which this invention belongs. Methods and materials are described herein for use in the present invention; other, suitable methods and materials known in the art can also be used. The materials, methods, and examples are illustrative only and not intended to be limiting. All publications, patent applications, patents, sequences, database entries, and other references mentioned herein are incorporated by reference in their entirety. In case of conflict, the present specification, including definitions, will control.

### DETAILED DESCRIPTION

The present disclosure provides new ternary and quaternary azeotropic and azeotrope-like compositions comprising hydrofluorocarbon mixtures. These compositions have utility in many of the applications formerly served by CFC compounds. The compositions of the present disclosure possess some or all of the desired properties of little or no environmental impact and the ability to dissolve oils, greases, and/or fluxes.

### Definitions and Abbreviations

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

As used herein, the term “consisting essentially of” is used to define a composition, method that includes materials, steps, features, components, or elements, in addition to those literally disclosed provided that these additional included materials, steps, features, components, or elements do not materially affect the basic and novel characteristic(s) of the claimed invention, especially the mode of action to achieve the desired result of any of the processes of the present invention. The term “consists essentially of” or “consisting essentially of” occupies a middle ground between “comprising” and “consisting of”.

Also, use of “a” or “an” are employed to describe elements and components described herein. This is done merely for convenience and to give a general sense of the scope of the invention. This description should be read to include one or at least one and the singular also includes the plural unless it is obvious that it is meant otherwise.

As used herein, the term “about” is meant to account for variations due to experimental error (e.g., plus or minus approximately 10% of the indicated value). All measurements reported herein are understood to be modified by the term “about”, whether or not the term is explicitly used, unless explicitly stated otherwise.

When an amount, concentration, or other value or parameter is given as either a range, preferred range or a list of upper preferable values and/or lower preferable values, this is to be understood as specifically disclosing all ranges formed from any pair of any upper range limit or preferred value and any lower range limit or preferred value, regardless of whether ranges are separately disclosed. Where a range of numerical values is recited herein, unless otherwise stated, the range is intended to include the endpoints thereof, and all integers and fractions within the range.

As recognized in the art, an azeotropic composition is an admixture of two or more different components which, when in liquid form and (1a) under a given constant pressure, will boil at a substantially constant temperature, which temperature may be higher or lower than the boiling temperatures of the individual components, or (1b) at a given constant temperature, will boil at a substantially constant pressure, which pressure may be higher or lower than the boiling pressure of the individual components, and (2) will boil at substantially constant composition, which phase compositions, while constant, are not necessarily equal (see, e.g., M. F. Doherty and M. F. Malone, Conceptual Design of Distillation Systems, McGraw-Hill (New York), 2001, 185).

A homogeneous azeotrope, in which a single vapor phase is in equilibrium with a single liquid phase, has, in addition to properties (1a), (1b), and (2) above, the composition of each component is the same in each of the coexisting equilibrium phases. The general term “azeotrope” is a commonly used alternative name for a homogeneous azeotrope.

As used herein, an “azeotrope-like” composition refers to a composition that behaves like an azeotropic composition (i.e., has constant boiling characteristics or a tendency not to fractionate upon boiling or evaporation). Hence, during boiling or evaporation, the vapor and liquid compositions, if they change at all, change only to a minimal or negligible extent. In contrast, the vapor and liquid compositions of non-azeotrope-like compositions change to a substantial degree during boiling or evaporation.

As used herein, the terms “azeotrope-like” or “azeotrope-like behavior” refer to compositions that exhibit dew point pressure and bubble point pressure with virtually no pressure differential. In some embodiments, the difference in the dew point pressure and bubble point pressure at a given temperature is 3% or less. In some embodiments, the difference in the bubble point and dew point pressures is 5% or less.

### Azeotrope and Azeotrope-Like Compositions

A composition, comprising:

i) perfluoroheptene;

ii) n-heptane; and

iii) a compound selected from tert-butyl acetate and isopropyl acetate;

wherein each of the n-heptane and tert-butyl acetate or isopropyl acetate are present in the composition in amounts effective to form an azeotrope composition or azeotrope-like composition with the perfluoroheptene.

In some embodiments, the perfluoroheptene comprises a mixture of perfluorohept-3-ene and perfluorohept-2-ene.

In some embodiments, the perfluoroheptene comprises about 85 to about 95 weight percent perfluorohept-3-ene and about 5 to about 15 weight percent perfluorohept-2-ene.

In some embodiments, the perfluoroheptene comprises about 90 weight percent perfluorohept-3-ene and about 10 weight percent perfluorohept-2-ene.

In some embodiments, the composition comprises perfluoroheptene, n-heptane, and tert-butyl acetate, wherein the n-heptane and tert-butyl acetate are each present in the composition in amounts effective to form an azeotrope composition or azeotrope-like composition with the perfluoroheptene.

In some embodiments, the composition comprises about 80 to about 99.8 weight percent perfluoroheptene, for example, about 80 to about 99, about 80 to about 95, about 80 to about 90, about 80 to about 85, about 85 to about 99.8, about 85 to about 99, about 85 to about 95, about 85 to about 90, about 90 to about 99.8, about 90 to about 99, about 90 to about 95, about 95 to about 99.8, about 95 to about 99, or about 99 to about 99.8 weight percent perfluoroheptene.

In some embodiments, the composition comprises about 0.1 to about 10 weight percent n-heptane, for example, about 0.1 to about 8, about 0.1 to about 6, about 0.1 to about 4, about 0.1 to about 2, about 0.1 to about 1, about 1 to about 10, about 1 to about 8, about 1 to about 6, about 1 to about 4, about 1 to about 2, about 2 to about 10, about 2 to about 8, about 2 to about 6, about 2 to about 4, about 4 to about 10, about 4 to about 8, about 4 to about 6, about 6 to about 10, about 6 to about 8, or about 8 to about 10 weight percent n-heptane.

In some embodiments, the composition comprises about 0.1 to about 10 weight percent tert-butyl acetate, for example, about 0.1 to about 8, about 0.1 to about 6, about 0.1 to about 4, about 0.1 to about 2, about 0.1 to about 1, about 1 to about 10, about 1 to about 8, about 1 to about 6, about 1 to about 4, about 1 to about 2, about 2 to about 10, about 2 to about 8, about 2 to about 6, about 2 to about 4, about 4 to about 10, about 4 to about 8, about 4 to about 6, about 6 to about 10, about 6 to about 8, or about 8 to about 10 weight percent tert-butyl acetate.

In some embodiments, the total weight percent of n-heptane and tert-butyl acetate in the composition is from about 5 to about 15 weight percent, for example, about 5 to about 10 or about 10 to about 15 weight percent.

In some embodiments, the composition consists essentially of perfluoroheptene, n-heptane, and tert-butyl acetate.

In some embodiments, the composition consists essentially of about 80 to about 99.8 weight percent perfluoroheptene, as described above, about 0.1 to about 10 weight percent n-heptane, as described above, and about 0.1 to about 10 weight percent tert-butyl acetate as described above.

In some embodiments, the composition consists essentially of about 85 to about 95 weight percent perfluoroheptene, as described above, and the total weight percent of n-heptane and tert-butyl acetate in the composition is from about 5 to about 15 weight percent, as described above.

In some embodiments, the composition consists essentially of about 88 to about 90 weight percent perfluoroheptene, about 5 about 7 weight percent n-heptane, and about 4 to about 6 weight percent tert-butyl acetate.

In some embodiments, the composition consists essentially of about 89 weight percent perfluoroheptene, about 6 weight percent n-heptane, and about 5 weight percent tert-butyl acetate.

In some embodiments, the composition comprising, consisting essentially of, or consisting of perfluoroheptene, n-heptane, and tert-butyl acetate is an azeotrope composition.

In some embodiments, the composition comprising, consisting essentially of, or consisting of perfluoroheptene, n-heptane, and tert-butyl acetate is an azeotrope-like composition.

In some embodiments, the composition comprising, consisting essentially of, or consisting of perfluoroheptene, n-heptane, and tert-butyl acetate has a boiling point of about 66° C. to about 67° C. at a pressure of about 101 kPa.

In some embodiments, the composition comprises perfluoroheptene, n-heptane, and isopropyl acetate, wherein the n-heptane and isopropyl acetate are each present in the composition in amounts effective to form an azeotrope composition or azeotrope-like composition with the perfluoroheptene.

In some embodiments, the composition comprises about 80 to about 99.8 weight percent perfluoroheptene, for example, about 80 to about 99, about 80 to about 95, about 80 to about 90, about 80 to about 85, about 85 to about 99.8, about 85 to about 99, about 85 to about 95, about 85 to about 90, about 90 to about 99.8, about 90 to about 99, about 90 to about 95, about 95 to about 99.8, about 95 to about 99, or about 99 to about 99.8 weight percent perfluoroheptene.

In some embodiments, the composition comprises about 0.1 to about 10 weight percent n-heptane, for example, about 0.1 to about 8, about 0.1 to about 6, about 0.1 to about 4, about 0.1 to about 2, about 0.1 to about 1, about 1 to about 10, about 1 to about 8, about 1 to about 6, about 1 to about 4, about 1 to about 2, about 2 to about 10, about 2 to about 8, about 2 to about 6, about 2 to about 4, about 4 to about 10, about 4 to about 8, about 4 to about 6, about 6 to about 10, about 6 to about 8, or about 8 to about 10 weight percent n-heptane.

In some embodiments, the composition comprises about 0.1 to about 10 weight percent isopropyl acetate, for example, about 0.1 to about 8, about 0.1 to about 6, about 0.1 to about 4, about 0.1 to about 2, about 0.1 to about 1, about 1 to about 10, about 1 to about 8, about 1 to about 6, about 1 to about 4, about 1 to about 2, about 2 to about 10, about 2 to about 8, about 2 to about 6, about 2 to about 4, about 4 to about 10, about 4 to about 8, about 4 to about 6, about 6 to about 10, about 6 to about 8, or about 8 to about 10 weight percent isopropyl acetate.

In some embodiments, the total weight percent of n-heptane and isopropyl acetate in the composition is from about 10 to about 15 weight percent, for example, about 10 to about 12 or about 12 to about 15 weight percent.

In some embodiments, the composition consists essentially of perfluoroheptene, n-heptane, and isopropyl acetate.

In some embodiments, the composition consists essentially of about 80 to about 99.8 weight percent perfluoroheptene, as described above, about 0.1 to about 10 weight percent n-heptane, as described above, and about 0.1 to about 10 weight percent isopropyl acetate, as described above.

In some embodiments, the composition consists essentially of about 85 to about 90 weight percent perfluoroheptene, as described above, and the total weight percent of n-heptane and isopropyl acetate in the composition is from about 10 to about 15 weight percent, as described above.

In some embodiments, the composition consists essentially of about 84 to about 86 weight percent perfluoroheptene, about 8 to about 10 weight percent n-heptane, and about 5 to about 7 weight percent isopropyl acetate.

In some embodiments, the composition consists essentially of about 85 weight percent perfluoroheptene, about 9 weight percent n-heptane, and about 6 weight percent isopropyl acetate.

In some embodiments, the composition comprising, consisting essentially of, or consisting of perfluoroheptene, n-heptane, and isopropyl acetate is an azeotrope composition.

In some embodiments, the composition comprising, consisting essentially of, or consisting of perfluoroheptene, n-heptane, and isopropyl acetate is an azeotrope-like composition.

In some embodiments, the composition comprising, consisting essentially of, or consisting of perfluoroheptene, n-heptane, and isopropyl acetate has a boiling point of about 66° C. to about 67° C. at a pressure of about 101 kPa.

The present application further provides a composition, comprising:

i) perfluoroheptene;

ii) HFC-4310mee; and

iii) trans-1,2-dichloroethylene;

wherein the HFC-4310mee and trans-1,2-dichloroethylene are each present in the composition in amounts effective to form an azeotrope composition or azeotrope-like composition with the perfluoroheptene.

In some embodiments, the perfluoroheptene comprises a mixture of perfluorohept-3-ene and perfluorohept-2-ene.

In some embodiments, the perfluoroheptene comprises about 85 to about 95 weight percent perfluorohept-3-ene and about 5 to about 15 weight percent perfluorohept-2-ene.

In some embodiments, the perfluoroheptene comprises about 90 weight percent perfluorohept-3-ene and about 10 weight percent perfluorohept-2-ene.

In some embodiments, the composition comprises about 0.1 to about 25 weight percent perfluoroheptene, for example, about 0.1 to about 20, about 0.1 to about 15, about 0.1 to about 10, about 0.1 to about 1, about 1 to about 25, about 1 to about 20, about 1 to about 15, about 1 to about 10, about 10 to about 25, about 10 to about 20, about 10 to about 15, about 15 to about 25, about 15 to about 20, or about 20 to about 25 weight percent perfluoroheptene.

In some embodiments, the composition comprises about 30 to about 40 weight percent HFC-4310mee, for example, about 30 to about 35 or about 35 to about 40 weight percent HFC-4310mee.

In some embodiments, the composition comprises about 40 to about 50 weight percent trans-1,2-dichloroethylene, for example, about 40 to about 45 or about 45 to about 50 weight percent trans-1,2-dichloroethylene.

In some embodiments, the composition consists essentially of perfluoroheptene, HFC-4310mee, and trans-1,2-dichloroethylene.

In some embodiments, the composition consists essentially of about 0.1 to about 25 weight percent perfluoroheptene, as described above, about 30 to about 40 weight percent HFC-4310mee, as described above, and about 40 to about 50 weight percent trans-1,2-dichloroethylene, as described above.

In some embodiments, the composition consists essentially of about 23 to about 25 weight percent perfluoroheptene, about 32 to about 34 weight percent HFC-4310mee, and about 42 to about 44 weight percent trans-1,2-dichloroethylene.

In some embodiments, the composition consists essentially of about 24 weight percent perfluoroheptene, about 33 weight percent HFC-4310mee, and about 43 weight percent trans-1,2-dichloroethylene.

In some embodiments, the composition comprising, consisting essentially of, or consisting of perfluoroheptene, HFC-4310mee, and trans-1,2-dichloroethylene is an azeotrope composition.

In some embodiments, the composition comprising, consisting essentially of, or consisting of perfluoroheptene, HFC-4310mee, and trans-1,2-dichloroethylene is an azeotrope-like composition.

In some embodiments, the composition comprising, consisting essentially of, or consisting of perfluoroheptene, HFC-4310mee, and trans-1,2-dichloroethylene has a boiling point of about 38° C. to about 40° C. at a pressure of about 101 kPa.

In some embodiments, the composition comprising, consisting essentially of, or consisting of perfluoroheptene, HFC-4310mee, and trans-1,2-dichloroethylene has a boiling point of about 39° C. at a pressure of about 101 kPa.

In some embodiments, the composition comprising perfluoroheptene, HFC-4310mee, and trans-1,2-dichloroethylene further comprises methanol, wherein the HFC-4310mee, trans-1,2-dichloroethylene, and methanol are each present in the composition in amounts effective to form an azeotrope composition or azeotrope-like composition with the perfluoroheptene.

In some embodiments, the composition comprises about 0.1 to about 25 weight percent perfluoroheptene, for example, about 0.1 to about 20, about 0.1 to about 15, about 0.1 to about 10, about 0.1 to about 1, about 1 to about 25, about 1 to about 20, about 1 to about 15, about 1 to about 10, about 10 to about 25, about 10 to about 20, about 10 to about 15, about 15 to about 25, about 15 to about 20, or about 20 to about 25 weight percent perfluoroheptene.

In some embodiments, the composition comprises about 30 to about 40 weight percent HFC-4310mee, for example, for example, about 30 to about 35 or about 35 to about 40 weight percent HFC-4310mee.

In some embodiments, the composition comprises about 40 to about 50 weight percent trans-1,2-dichloroethylene, for example, for example, about 40 to about 45 or about 45 to about 50 weight percent trans-1,2-dichloroethylene.

In some embodiments, the composition comprises about 0.1 to about 5 weight percent methanol, for example, about 0.1 to about 4, about 0.1 to about 3, about 0.1 to about 2, about 0.1 to about 1, about 1 to about 5, about 1 to about 4, about 1 to about 3, about 1 to about 2, about 2 to about 5, about 2 to about 4, about 2 to about 3, about 3 to about 5, about 3 to about 4, or about 4 to about 5 weight percent methanol.

In some embodiments, the composition consists essentially of perfluoroheptene, HFC-4310mee, trans-1,2-dichloroethylene, and methanol.

In some embodiments, the composition consists essentially of about 0.1 to about 25 weight percent perfluoroheptene, as described above, about 30 to about 40 weight percent HFC-4310mee, as described above, about 40 to about 50 weight percent trans-1,2-dichloroethylene, as described above, and about 0.1 to about 5 weight percent methanol, as described above.

In some embodiments, the composition consists essentially of about 21 to about 23 weight percent perfluoroheptene, about 31 to about 33 weight percent HFC-4310mee, about 41 to about 43 weight percent trans-1,2-dichloroethylene, and about 2 to about 4 weight percent methanol.

In some embodiments, the composition consists essentially of about 22.5 weight percent perfluoroheptene, about 32.5 weight percent HFC-4310mee, about 42 weight percent trans-1,2-dichloroethylene, and about 3 weight percent methanol.

In some embodiments, the composition comprising, consisting essentially of, or consisting of perfluoroheptene, HFC-4310mee, trans-1,2-dichloroethylene, and methanol is an azeotrope composition.

In some embodiments, the composition comprising, consisting essentially of, or consisting of perfluoroheptene, HFC-4310mee, trans-1,2-dichloroethylene, and methanol is an azeotrope-like composition.

In some embodiments, the composition comprising, consisting essentially of, or consisting of perfluoroheptene, HFC-4310mee, trans-1,2-dichloroethylene, and methanol has a boiling point of about 35° C. to about 37° C. at a pressure of about 101 kPa.

In some embodiments, the composition comprising, consisting essentially of, or consisting of perfluoroheptene, HFC-4310mee, trans-1,2-dichloroethylene, and methanol has a boiling point of about 36° C. at a pressure of about 101 kPa.

### Methods of Use

In some embodiments, compositions described herein are useful as cleaning agents, defluxing agents, and/or degreasing agents. Accordingly, the present application provides a process of cleaning a surface, comprising contacting a composition provided herein with said surface. In some embodiments, the process comprises removing a residue from a surface or substrate, comprising contacting the surface or substrate with a composition provided herein and recovering the surface or substrate from the composition.

In some embodiments, the present application further provides a process for dissolving a solute, comprising contacting and mixing said solute with a sufficient quantity of a composition provided herein.

In some embodiments, the surface or substrate may be an integrated circuit device, in which case, the residue comprises rosin flux or oil. The integrated circuit device may be a circuit board with various types of components, such as Flip chips, μBGAs, or Chip scale packaging components. The surface or substrate may additionally be a metal surface such as stainless steel. The rosin flux may be any type commonly used in the soldering of integrated circuit devices, including but not limited to RMA (rosin mildly activated), RA (rosin activated), WS (water soluble), and OA (organic acid). Oil residues include but are not limited to mineral oils, motor oils, and silicone oils.

In some embodiments, the present application provides a process for removing at least a portion of water from the surface of a wetted substrate, or surface, or device, comprising contacting the substrate, surface, or device with a composition provided herein, and then removing the substrate, surface, or device from contact with the composition.

In some embodiments, the composition provided herein further comprises at least one surfactant suitable for dewatering or drying the substrate. Exemplary surfactants include, but are not limited to, alkyl dimethyl ammonium isooctyl phosphates, tert-alkyl amines (e.g., tert-butyl amine), perfluoro alkyl phosphates, dimethyl decenamide, fluorinated alkyl polyether, quaternary amines (e.g., ammonium salts), and glycerol monostearate.

The means for contacting a device, surface, or substrate is not critical and may be accomplished, for example, by immersion of the device, surface, or substrate, in a bath containing the composition provided herein, spraying the device, surface, or substrate with the composition provided herein, or wiping the device, surface, or substrate with a material (e.g., a cloth) that has been wet with the composition. Alternatively, a composition provided herein may also be used in a vapor degreasing or defluxing apparatus designed for such residue removal. Such vapor degreasing or defluxing equipment is available from various suppliers such as Forward Technology (a subsidiary of the Crest Group, Trenton, N.J.), Trek Industries (Azusa, Calif.), and Ultronix, Inc. (Hatfield, Pa.) among others.

### EXAMPLES

The invention will be described in greater detail by way of specific examples. The following examples are offered for illustrative purposes, and are not intended to limit the invention in any manner. Those of skill in the art will readily recognize a variety of non-critical parameters which can be changed or modified to yield essentially the same results.

### Example 1. Vapor-Liquid Equilibrium Analysis and Distillation Analysis

### Vapor-Liquid Equilibrium Analysis

The PTx method is a known method for experimentally measuring vapor-liquid phase equilibrium (VLE) data of a mixture. The measurements can be made either isothermally or isobarically. The isothermal method requires measurement of the total pressure of mixtures of known composition at constant temperature. In this method, the total absolute pressure in a cell of known volume is measured at a constant temperature for various known compositions of the two compounds. The isobaric method requires measurement of the temperature of mixtures of known composition at constant pressure. In this method, the temperature in a cell of known volume is measured at a constant pressure for various known compositions of the two compounds. Use of the PTx Method is described in detail in “Phase Equilibrium in Process Design”, Wiley-Interscience Publisher, 1970, written by Harold R. Null, on pages 124 to 126, the disclosure of which is incorporated herein by reference in its entirety.

The measured data points can be converted into equilibrium vapor and liquid compositions in the PTx cell by using an activity coefficient equation model, such as the Non-Random, Two-Liquid (NRTL) equation, to represent liquid phase nonidealities. Use of an activity coefficient equation, such as the NRTL equation is described in detail in “The Properties of Gases and Liquids,” 4th edition, published by McGraw Hill, written by Reid, Prausnitz and Poling, on pages 241 to 387, and in “Phase Equilibria in Chemical Engineering,” published by Butterworth Publishers, 1985, written by Stanley M. Walas, pages 165 to 244, the disclosure of which is incorporated herein by reference in its entirety. Without wishing to be bound by any theory or explanation, it is believed that the NRTL equation, together with the PTx cell data, sufficiently predicts the vapor-liquid phase equilibrium behavior of the various mixture compositions of the present invention and as well as the behavior of these mixtures in multi-stage separation equipment such as distillation columns.

### Distillation Analysis

Mixtures were prepared and distilled in a 25-plate distillation column at a pressure of 760 mm Hg per standard ASTM method D 1078. Head and flask temperatures were monitored directly to 1° C. Distillate samples were taken throughout the distillation for determination of composition by gas chromatography.

### Azeotrope Compositions

Table 1 shows the azeotrope range and azeotrope point determined for various ternary and quaternary compositions of perfluoroheptene by distillation at atmospheric pressure (approximately 101 kPa). The perfluoroheptene used in each of the experiments was a mixture of 90 weight percent perfluorohept-3-ene and 10 weight percent perfluorohept-2-ene. PFH=perfluoroheptene; TBAC=tert-butyl acetate; iPrOAc=isopropyl acetate; trans-DCE=trans-1,2-dichloroethylene; MeOH=methanol.

TABLE 1

| | Boiling Point | Azeotrope Range | Azeotrope Point |
|---|---|---|---|
| Composition | (° C.) | (wt %) | (wt %) |
| PFH, TBAC, heptane | 66.4 | 0 to 10% TBAC & Heptane | 88.9% PFH |
| | | | 4.6% t-BAC |
| | | | 6.5% heptane |
| PFH, iPrOAc, heptane | 66.2 | 0 to 10% iPrOAc & Heptane | 85.4% PFH |
| | | | 9.0% iPrOAc |
| | | | 5.6% heptane |
| PFH, HFC-4310mee, | 38.8 | 0.1% to 25% PFH | 23.9% PFH |
| trans-DCE | | 30% to 40% HFC-4310mee | 33.3% HFC-4310mee |
| | | 40% to 50% trans-DCE | 42.8% trans-DCE |
| PFH, HFC-4310mee, | 35.9 | 0.1% to 25% PFH | 22.5% PFH |
| trans-DCE, MeOH | | 30% to 40% HFC-4310mee | 32.5% HFC-4310mee |
| | | 40% to 50% trans-DCE | 42.2% trans-DCE |
| | | 0.1% to 5% MeOH | 3.1% MeOH |

### Example 2. Flammability and Flash Point Testing

Flash point testing was performed using a mixture of perfluoroheptene (PFH) and tert-butyl acetate (TBAC). The flash point was determined using ASTM D56-05(2010), the standard test method for flash point by Tag closed Cup Tester. As demonstrated in Table 2, the boiling point in the tested range was constant and was consistent with azeotrope-like behavior. Mixtures denoted as “NF” were determined to be non-flammable.

TABLE 2

| PFH | TBAC | Boiling Point | Flash Point |
|---|---|---|---|
| (wt %) | (wt %) | (° C.) | (° C.) |
| 94 | 6 | 69.0 | NF |
| 92 | 8 | 69.0 | NF |
| 90 | 10 | 69.0 | NF |
| 81 | 11 | 69.0 | NF |
| 87 | 13 | 69.0 | NF |

### Example 3. Metal Cleaning Analysis

Perfluoroheptene (PFH) was shown to be effective in removing a variety of machining oils used in metal fabrication process. Example of ultrasonic cleaning of oily/greasy metal (carbon steel) coupons soaked in PFH is shown below in Table 3.

TABLE 3

| Oil Type | % oil removed |
|---|---|
| Mineral Oil | 94.1 |
| Royco Hydraulic fluid | 98.7 |
| Mag Oil | 100 |
| Honing Oil | 94.4 |
| Vac Oil | 94.9 |

### Example 4. Carrier Fluid Analysis

Perfluoroheptene (PFH) was determined to be an excellent carrier fluid for hexamethyldisiloxane, as shown in Table 4. Blends of PFH and hexamethyldisiloxe would be used, for example, for silicon deposition/removal on medical devices including, but not limited to, surgical needles & tubing, artificial skin & prosthetics, and contact lenses. Blends of PFH and hexamethyldisiloxane was also shown to be useful as carrier fluids for formulating silicone adhesives, sealant, and coatings. PFH may also be useful as a cosmetic carrier fluid for deposition of silicone on skin and hair for improved feel benefit. As shown below in Table 4, PFH was shown to be as a non-flammable carrier fluid for Krytox lubricants and can be used to deliver high performance lubrication and anti-corrosion coatings on bearing, valves & seals for improved reliability. PFH also demonstrated good solubility for Zonyl fluoroadditives used in water proof coatings, oil-repellency surfaces and anti-contamination coating. PFH can also be useful as a carrier fluid for fluorosurfactants used for water displacement drying of reflective and refractive surfaces such as optical and medical devices.

TABLE 4

| Additive | PFH | Solubility in PFH |
|---|---|---|
| Hexamethyldisiloxane | Miscible | 100% |
| Krytox Lubricants | Miscible | >25% |
| Zonyl Surfactant | Miscible | >10% |

### Example 5. Cleaning Effectiveness Factor (CEF) Analysis of Perfluoroheptene/HFC-4310mee/trans-1,2-Dichloroethylene (PFH/HFC-4310mee/trans-DCE) Blend

A composition containing 24% w/w PFH, 33% w/w HFC-4310mee, and 43% w/w trans-DCE was decanted into a 1000 mL beaker with a condensing coil and heated to the boiling point (38.8° C.) using a hot plate. Three pre-cleaned 304 stainless steel coupons were weighed on an analytical balance (initial weight). A thin film of Mobil Grease 28 was applied to one surface of each coupon and excess was removed with a wipe. Each coupon was then reweighed to determine the soiled weight and subsequently placed in the vapor phase of the boiling solvent composition for ten minutes. The coupons were then removed and allowed to dry and off-gas for ten minutes before reweighing (post cleaned weight) to determine the cleaning effectiveness factor (CEF) of the composition. Results of the cleaning analysis are shown in Table 5 and the CEF was determined according to Equation 1:

CEF=(soiled weight−post cleaned weight)/(soiled weight−initial weight)

TABLE 5

| | Initial Weight | Soiled Weight | Post Cleaned | CEF |
|---|---|---|---|---|
| Coupon # | (g) | (g) | Weight (g) | (%) |
| 5-A | 19.6699 | 19.7464 | 19.67 | 99.9 |
| 5-B | 19.6436 | 19.7008 | 19.6437 | 99.8 |
| 5-C | 19.6825 | 19.7375 | 19.684 | 97.3 |

### Example 6. Cleaning Effectiveness Factor (CEF) Analysis of Perfluoroheptene/HFC-4310mee/trans-1,2-Dichloroethylene/Methanol (PFH/HFC-4310mee/trans-DCE/MeOH) Blend

A composition containing 22.5% w/w PFH, 32.5% w/w HFC-4310mee, 42% w/w trans-DCE, and 3% w/w MeOH was decanted into a 1000 mL beaker with a condensing coil and heated to the boiling point (35.9° C.) using a hot plate. Three precleaned plastic printed circuit board (PCB) coupons were weighed on an analytical balance (initial weight). A thin film of Kester 185 flux 28 was applied to one surface of each coupon and excess was removed with a wipe. The flux was left to dry on the PCB coupon for 30 minutes before cleaning. Each coupon was then reweighed to determine the soiled weight and subsequently placed in the vapor phase of the boiling composition for ten minutes. The coupons were then removed and allowed to dry and off-gas for ten minutes before reweighing (post cleaned weight) to determine the cleaning effectiveness factor of the composition. A control coupon was used to account for solvent absorbed into the plastic PCB coupon. Results of the cleaning analysis are shown in Table 6 and the CEF was determined according to Equation 1.

TABLE 6

| | | | Post | | | |
|---|---|---|---|---|---|---|
| | Initial | Soiled | Cleaned | | | Corrected |
| Coupon | Weight | Weight | Weight | Absorption | CEF | CEF |
| # | (g) | (g) | (g) | Factor | (%) | (%) |
| 6-A | 8.8687 | 8.9341 | 8.8788 | | 84.6 | 98.5 |
| 6-B | 8.5693 | 8.6354 | 8.5771 | | 88.2 | 101.6 |
| 6-C | 7.4779 | 7.563 | 7.4887 | | 87.3 | 96.4 |
| Control | 8.634 | | 8.6429 | 1.001030808 | | |

### Example 7. Cleaning Effectiveness Factor (CEF) Analysis of Perfluoroheptene/Isopropyl Acetate/Heptane (PFH/iPrOAc/Heptane) Blend

A composition containing 85% w/w PFH, 9.0% w/w iPrOAc, and 6% w/w heptane was decanted into a 1000 mL beaker with a condensing coil and heated to the boiling point (66.2° C.) using a hot plate. Three precleaned 304 stainless steel coupons were weighed on an analytical balance (initial weight). A thin film of Mobil 600W cylinder oil was applied to one surface of each coupon and excess was removed with a wipe. Each coupon was then reweighed to determine the soiled weight and subsequently placed in the vapor phase of the boiling composition for ten minutes. The coupons were then removed and allowed to dry and off-gas for ten minutes before reweighing (post cleaning weight) to determine the cleaning effectiveness factor of the solvent blend. Results of the cleaning analysis are shown in Table 7 and the CEF was determined according to Equation 1.

TABLE 7

| | Initial Weight | Soiled Weight | Post Cleaned | CEF |
|---|---|---|---|---|
| Coupon # | (g) | (g) | Weight (g) | (%) |
| 7-A | 19.6835 | 19.7257 | 19.6834 | 100.2 |
| 7-B | 19.644 | 19.6957 | 19.644 | 100.0 |
| 7-C | 19.6704 | 19.7384 | 19.6705 | 99.9 |

### Example 8. Cleaning Effectiveness Factor (CEF) Analysis of Perfluoroheptene/tert-Butyl Acetate/Heptane (PFH/TBAC/Heptane) Blend

A composition containing 89% w/w PFH, 4.5% w/w TBAC, and 6.5% w/w heptane was decanted into a 1000 mL beaker with a condensing coil and heated to the boiling point (66.4° C.) using a hot plate. Three precleaned 304 stainless steel coupons were weighed on an analytical balance (initial weight). A thin film of mineral oil was applied to one surface of each coupon and excess was removed with a wipe. Each coupon was then reweighed to determine the soiled weight the placed in the vapor phase of the boiling solvent composition for ten minutes. Coupons were then removed and allowed to dry and off-gas for ten minutes before reweighing (post cleaned weight) to determine the cleaning effectiveness factor of the solvent blend. Results of the cleaning analysis are shown in Table 8 and the CEF was determined according to Equation 1.

TABLE 8

| | Initial Weight | Soiled Weight | Post Cleaned | CEF |
|---|---|---|---|---|
| Coupon # | (g) | (g) | Weight (g) | (%) |
| 8-A | 19.6834 | 19.7317 | 19.6836 | 99.6 |
| 8-B | 19.6438 | 19.702 | 19.644 | 99.7 |
| 8-C | 19.6704 | 19.7143 | 19.6702 | 100.5 |

### Other Embodiments

1. In some embodiments, the present application provides a composition, comprising:

i) perfluoroheptene;

ii) n-heptane; and

iii) a compound selected from tert-butyl acetate and isopropyl acetate;

wherein each of the n-heptane and tert-butyl acetate or isopropyl acetate are present in the composition in amounts effective to form an azeotrope composition or azeotrope-like composition with the perfluoroheptene.
2. The composition of embodiment 1, wherein the perfluoroheptene comprises about 90 weight percent perfluorohept-3-ene and about 10 weight percent perfluorohept-2-ene.
3. The composition of embodiment 1 or 2, wherein the composition comprises perfluoroheptene, n-heptane, and tert-butyl acetate, wherein the n-heptane and tert-butyl acetate are each present in the composition in amounts effective to form an azeotrope composition or azeotrope-like composition with the perfluoroheptene.
4. The composition of any one of embodiments 1 to 3, wherein the composition comprises about 80 to about 99.8 weight percent perfluoroheptene.
5. The composition of any one of embodiments 1 to 4, wherein the composition comprises about 0.1 to about 10 weight percent n-heptane.
6. The composition of any one of embodiments 1 to 5, wherein the composition comprises about 0.1 to about 10 weight percent tert-butyl acetate.
7. The composition of any one of embodiments 1 to 4, wherein the total weight percent of n-heptane and tert-butyl acetate in the composition is from about 5 to about 15 weight percent.
8. The composition of any one of embodiments 1 to 7, wherein the composition consists essentially of perfluoroheptene, n-heptane, and tert-butyl acetate.
9. The composition of any one of embodiments 1 to 3 and 8, wherein the composition consists essentially of about 80 to about 99.8 weight percent perfluoroheptene, about 0.1 to about 10 weight percent n-heptane, and about 0.1 to about 10 weight percent tert-butyl acetate.
10. The composition of any one of embodiments 1 to 3 and 8, wherein the composition consists essentially of about 85 to about 95 weight percent perfluoroheptene, and the total weight percent of n-heptane and tert-butyl acetate in the composition is from about 5 to about 15 weight percent.
11. The composition of any one of embodiments 1 to 3 and 8, wherein the composition consists essentially of about 89 weight percent perfluoroheptene, about 6 weight percent n-heptane, and about 5 weight percent tert-butyl acetate.
12. The composition of any one of embodiments 1 to 11, wherein the composition is an azeotrope composition.
13. The composition of any one of embodiments 1 to 12, wherein the composition has a boiling point of about 66° C. to about 67° C. at a pressure of about 101 kPa.
14. The composition of embodiment 1 or 2, wherein the composition comprises perfluoroheptene, n-heptane, and isopropyl acetate, wherein the n-heptane and isopropyl acetate are each present in the composition in amounts effective to form an azeotrope composition or azeotrope-like composition with the perfluoroheptene.
15. The composition of any one of embodiments 1, 2, and 14, wherein the composition comprises about 80 to about 99.8 weight percent perfluoroheptene.
16. The composition of any one of embodiments 1, 2, 14, and 15, wherein the composition comprises about 0.1 to about 10 weight percent n-heptane.
17. The composition of any one of embodiments 1, 2, and 14 to 16, wherein the composition comprises about 0.1 to about 10 weight percent isopropyl acetate.
18. The composition of any one of embodiments 1, 2, and 14 to 16, wherein the total weight percent of n-heptane and isopropyl acetate in the composition is from about 10 to about 15 weight percent.
19. The composition of any one of embodiments 1, 2, and 14, wherein the composition consists essentially of perfluoroheptene, n-heptane, and isopropyl acetate.
20. The composition of any one of embodiments 1, 2, 14, and 19, wherein the composition consists essentially of about 80 to about 99.8 weight percent perfluoroheptene, about 0.1 to about 10 weight percent n-heptane, and about 0.1 to about 10 weight percent isopropyl acetate.
21. The composition of any one of embodiments 1, 2, 14, and 19, wherein the composition consists essentially of about 85 to about 90 weight percent perfluoroheptene, and the total weight percent of n-heptane and isopropyl acetate in the composition is from about 10 to about 15 weight percent.
22. The composition of any one of embodiments 1, 2, 14, and 19, wherein the composition consists essentially of about 85 weight percent perfluoroheptene, about 9 weight percent n-heptane, and about 6 weight percent isopropyl acetate.
23. The composition of any one of embodiments 1, 2, and 14 to 22, wherein the composition is an azeotrope composition.
24. The composition of any one of embodiments 1, 2, and 14 to 23, wherein the composition has a boiling point of about 66° C. to about 67° C. at a pressure of about 101 kPa.
25. In some embodiments, the present application further provides a composition, comprising:

i) perfluoroheptene;

ii) HFC-4310mee; and

iii) trans-1,2-dichloroethylene;

wherein the HFC-4310mee and trans-1,2-dichloroethylene are each present in the composition in amounts effective to form an azeotrope composition or azeotrope-like composition with the perfluoroheptene.
26. The composition of embodiment 25, wherein the perfluoroheptene comprises about 90 weight percent perfluorohept-3-ene and about 10 weight percent perfluorohept-2-ene.
27. The composition of embodiment 25 or 26, wherein the composition comprises about 0.1 to about 25 weight percent perfluoroheptene.
28. The composition of any one of embodiments 25 to 27, wherein the composition comprises about 30 to about 40 weight percent HFC-4310mee.
29. The composition of any one of embodiments 25 to 28, wherein the composition comprises about 40 to about 50 weight percent trans-1,2-dichloroethylene.
30. The composition of any one of embodiments 25 to 29, wherein the composition consists essentially of perfluoroheptene, HFC-4310mee, and trans-1,2-dichloroethylene.
31. The composition of any one of embodiments 25, 26, and 30, wherein the composition consists essentially of about 0.1 to about 25 weight percent perfluoroheptene, about 30 to about 40 weight percent HFC-4310mee, and about 40 to about 50 weight percent trans-1,2-dichloroethylene.
32. The composition of any one of embodiments 25, 26, and 30, wherein the composition consists essentially of about 24 weight percent perfluoroheptene, about 33 weight percent HFC-4310mee, and about 43 weight percent trans-1,2-dichloroethylene.
33. The composition of any one of embodiments 25 to 32, wherein the composition is an azeotrope composition.
34. The composition of any one of embodiments 25 to 33, wherein the composition has a boiling point of about 39° C. at a pressure of about 101 kPa.
35. The composition of any one of embodiments 25 to 34, further comprising methanol, wherein the HFC-4310mee, trans-1,2-dichloroethylene, and methanol are each present in the composition in amounts effective to form an azeotrope composition or azeotrope-like composition with the perfluoroheptene.
36. The composition of embodiment 35, wherein the composition comprises about 0.1 to about 25 weight percent perfluoroheptene.
37. The composition of embodiment 35 or 36, wherein the composition comprises about 30 to about 40 weight percent HFC-4310mee.
38. The composition of any one of embodiments 35 to 37, wherein the composition comprises about 40 to about 50 weight percent trans-1,2-dichloroethylene.
39. The composition of any one of embodiments 35 to 38, wherein the composition comprises about 0.1 to about 5 weight percent methanol.
40. The composition of any one of embodiments 35 to 39, wherein the composition consists essentially of perfluoroheptene, HFC-4310mee, trans-1,2-dichloroethylene, and methanol.
41. The composition of embodiment 35, wherein the composition consists essentially of about 0.1 to about 25 weight percent perfluoroheptene, about 30 to about 40 weight percent HFC-4310mee, about 40 to about 50 weight percent trans-1,2-dichloroethylene, and about 0.1 to about 5 weight percent methanol.
42. The composition of embodiment 35, wherein the composition consists essentially of about 22.5 weight percent perfluoroheptene, about 32.5 weight percent HFC-4310mee, about 42 weight percent trans-1,2-dichloroethylene, and about 3 weight percent methanol.
43. The composition of any one of embodiments 35 to 42, wherein the composition is an azeotrope composition.
44. The composition of any one of embodiments 35 to 43, wherein the composition has a boiling point of about 36° C. at a pressure of about 101 kPa.
45. In some embodiments, the present application provides a composition comprising:

about 23% to about 25% w/w perfluoroheptene, about 32% to about 34% w/w HFC-4310mee, and about 42% to about 44% w/w trans-1,2-dichloroethylene; or

about 21.5% to about 23.5% w/w perfluoroheptene, about 31.5% to about 33.5% w/w HFC-4310mee, about 41% to about 43% w/w trans-1,2-dichloroethylene, and about 2% to about 4% w/w methanol;

about 84% to about 86% w/w perfluoroheptene, about 8% to about 10% w/w isopropyl acetate, and about 5% to about 7% w/w heptane; or

about 88% to about 90% w/w perfluoroheptene, about 3.5% to about 5.5% w/w tert-butyl acetate, and about 5.5% to about 7.5% w/w heptane.
46. In some embodiments, the present application provides a composition comprising:

about 24% w/w perfluoroheptene, about 33% w/w HFC-4310mee, and about 43% w/w trans-1,2-dichloroethylene; or

about 22.5% w/w perfluoroheptene, about 32.5% w/w HFC-4310mee, about 42% w/w trans-1,2-dichloroethylene, and about 3% w/w methanol;

about 85% w/w perfluoroheptene, about 9.0% w/w isopropyl acetate, and about 6% w/w heptane; or

about 89% w/w perfluoroheptene, about 4.5% w/w tert-butyl acetate, and about 6.5% w/w heptane.
47. The composition of embodiment 45 or 46, wherein the perfluoroheptene comprises about 90 weight percent perfluorohept-3-ene and about 10 weight percent perfluorohept-2-ene.
48. The composition of any one of embodiments 45 to 47, wherein the composition is an azeotrope composition.
49. A process for dissolving a solute, comprising contacting and mixing said solute with a sufficient quantity of the composition of any one of embodiments 1 to 48.
50. A process of cleaning a surface, comprising contacting the composition of any one of embodiments 1 to 48.
51. A process for removing at least a portion of water from the surface of a wetted substrate, comprising contacting the substrate with the composition of any one of embodiments 1 to 48, and then removing the substrate from contact with the composition.
52. The process of embodiment 51, wherein composition further comprises at least one surfactant suitable for dewatering or drying the substrate.

It is to be understood that while the invention has been described in conjunction with the detailed description thereof, the foregoing description is intended to illustrate and not limit the scope of the invention, which is defined by the scope of the appended claims. Other aspects, advantages, and modifications are within the scope of the following claims. It should be appreciated by those persons having ordinary skill in the art(s) to which the present invention relates that any of the features described herein in respect of any particular aspect and/or embodiment of the present invention can be combined with one or more of any of the other features of any other aspects and/or embodiments of the present invention described herein, with modifications as appropriate to ensure compatibility of the combinations. Such combinations are considered to be part of the present invention contemplated by this disclosure.

What is claimed is:

1. A composition, comprising:
i) perfluoroheptene;
ii) n-heptane; and
iii) a compound selected from tert-butyl acetate and isopropyl acetate;
wherein each of the n-heptane and tert-butyl acetate or isopropyl acetate are present in the composition in amounts effective to form an azeotrope composition or azeotrope-like composition with the perfluoroheptene.

2. The composition of claim 1, wherein the perfluoroheptene comprises about 90 weight percent perfluorohept-3-ene and about 10 weight percent perfluorohept-2-ene.

3. The composition of claim 2, wherein the composition comprises perfluoroheptene, n-heptane, and tert-butyl acetate, wherein the n-heptane and tert-butyl acetate are each present in the composition in amounts effective to form an azeotrope composition or azeotrope-like composition with the perfluoroheptene.

4. The composition of claim 3, wherein the composition consists essentially of about 80 to about 99.8 weight percent perfluoroheptene, about 0.1 to about 10 weight percent n-heptane, and about 0.1 to about 10 weight percent tert-butyl acetate.

5. The composition of claim 2, wherein the composition comprises perfluoroheptene, n-heptane, and isopropyl acetate, wherein the n-heptane and isopropyl acetate are each present in the composition in amounts effective to form an azeotrope composition or azeotrope-like composition with the perfluoroheptene.

6. The composition of claim 5, wherein the composition consists essentially of about 80 to about 99.8 weight percent perfluoroheptene, about 0.1 to about 10 weight percent n-heptane, and about 0.1 to about 10 weight percent isopropyl acetate.

7. A composition, comprising:
i) perfluoroheptene;
ii) HFC-4310mee; and
iii) trans-1,2-dichloroethylene;
wherein the HFC-4310mee and trans-1,2-dichloroethylene are each present in the composition in amounts effective to form an azeotrope composition or azeotrope-like composition with the perfluoroheptene.

8. The composition of claim 7, wherein the perfluoroheptene comprises about 90 weight percent perfluorohept-3-ene and about 10 weight percent perfluorohept-2-ene.

9. The composition of claim 8, wherein the composition consists essentially of about 0.1 to about 25 weight percent perfluoroheptene, about 30 to about 40 weight percent HFC-4310mee, and about 40 to about 50 weight percent trans-1,2-dichloroethylene.

10. The composition of claim 7, further comprising methanol, wherein the HFC-4310mee, trans-1,2-dichloroethylene, and methanol are each present in the composition in amounts effective to form an azeotrope composition or azeotrope-like composition with the perfluoroheptene.

11. The composition of claim 10, wherein the perfluoroheptene comprises about 90 weight percent perfluorohept-3-ene and about 10 weight percent perfluorohept-2-ene

12. The composition of claim 11, wherein the composition consists essentially of about 0.1 to about 25 weight percent perfluoroheptene, about 30 to about 40 weight percent HFC-4310mee, about 40 to about 50 weight percent trans-1,2-dichloroethylene, and about 0.1 to about 5 weight percent methanol.

13. A process for dissolving a solute, comprising contacting and mixing said solute with a sufficient quantity of the composition of claim 1.

14. A process of cleaning a surface, comprising contacting the composition of claim 1 with said surface.

15. A process for removing at least a portion of water from the surface of a wetted substrate, comprising contacting the substrate with the composition of claim 1, and then removing the substrate from contact with the composition.

16. A process for dissolving a solute, comprising contacting and mixing said solute with a sufficient quantity of the composition of claim 7.

17. A process of cleaning a surface, comprising contacting the composition of claim 7 with said surface.

18. A process for removing at least a portion of water from the surface of a wetted substrate, comprising contacting the substrate with the composition of claim 7, and then removing the substrate from contact with the composition.

19. A process for dissolving a solute, comprising contacting and mixing said solute with a sufficient quantity of the composition of claim 10.

20. A process of cleaning a surface, comprising contacting the composition of claim 10 with said surface.

21. A process for removing at least a portion of water from the surface of a wetted substrate, comprising contacting the substrate with the composition of claim 10, and then removing the substrate from contact with the composition.
